(19) United States
(12) Patent Application Publication
(10) Pub. No.: US 2009/0157890 A1
(43) Pub. Date: Jun. 18, 2009

(54) DEVICE AND METHOD FOR TRANSMITTING REAL TIME DATA

(75) Inventor: Paul Lanz, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/719,584

(22) PCT Filed: Sep. 15, 2005
(86) PCT No.: PCT/EP2005/009907

§ 371 Date: May 17, 2007

(30) Foreign Application Priority Data
Nov. 20, 2004 (DE) 10 2004 056 173.7

(51) Int. Cl. G06F 15/16

(52) U.S. Cl. 709/231

(57) ABSTRACT

The invention relates to a device for transmitting real time data. The device comprises an interface (2), via which the data to be transmitted is collected and transmitted to a laptop computer (4), without local buffering, by a single transmission operation using a mobile telephone (3), pocket PC, PDA, smart phone or similar handheld equipment.

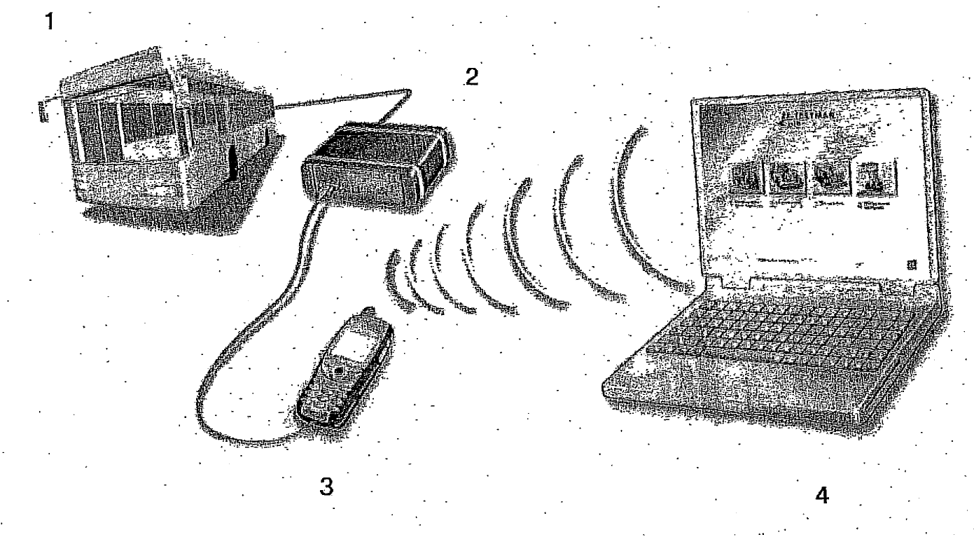

This application is a national stage completion of PCT/EP2005/009907 filed Sep. 15, 2005 which claims priority from German Application Serial No. 10 2004 056 173.3 filed Nov. 20, 2004.

### FIELD OF THE INVENTION

The present invention relates to an apparatus as well as a method for real-time data transmission.

### BACKGROUND OF THE INVENTION

DE 100 12 272 B4 describes a method for storing data in the computer-supported equipment of a means of transportation, in particular, for motor vehicles. This method enables updating in vehicles the software of computer-aided equipment, or providing exchange equipment with operational software, and updating stored parameters of the vehicle and the equipment, respectively. According to this method, new operational software as well as specific parameters of the vehicle, the manufacturer, or parameters of the body manufacturer may be written, in a non-volatile memory of the computer-supported equipment by means of a telecommunications device, while old stored data is overwritten. Transmission of the updated software and/or the data, in particular, the vehicle parameters, to the vehicle from a stationary location may be carried out by means of any data transmission method, for example, a cellular phone, a satellite, a radio link system or the Internet, or directly by a diagnostic link, via a laptop/PC or an incorporated laptop/PC interface.

From DE 102 31 671 A1, a method for preforming diagnosis of a motor vehicle is known. For diagnostic purposes, an electronic testing device is connected, via a signal connection, to a control device in the vehicle. The testing device only sends and receives data signals within the framework of the diagnosis. Preferably, the decision of whether to send and/or carry out a diagnosis request is made each time by the diagnosis or control device.

With prior art methods, data transmission has to be actively initiated or requested, and the data has to be respectively collected and stored in the vehicle and be transmitted independently therefrom. When transmitting data, via a cellular phone, conversion times are present at each data delivery, which do not permit real-time data transmission.

Consequently, there are no descriptions of a method, within the prior art, of initiating a diagnosis independently of a request. Due to lacking checks by the control device, necessary inspections may, therefore, be overlooked. Further, accomplishing a diagnosis requires the vehicle to be left at a specialized garage because the appropriate testing devices are only available there. Verification or diagnosis must, therefore, be performed at the stationary site, and the data still can not be transmitted or displayed in real time.

### SUMMARY OF THE INVENTION

Against this background, the object of the present invention is to provide an apparatus as well as a method for real-time data transmission which allows, at any time, active intervention in computer-aided devices of the vehicles.

The object of the present invention is solved by a generic apparatus for real-time data transmission.

By using an adaptive, intelligent interface in which all the available data and information is compiled and bundled, via a cellular phone, pocket PC, PDA, smartphone or similar handheld devices, the data may be displayed in real time. This includes, for example, online diagnosis of vehicles, boats or machines, and transmission of values such as speed, pressure or flow, retrieving error memory information, as well as the display and recording of available data in real time. Once the adaptive interface has received the data request, the request will execute a loop until a STOP command is issued. As this data is always sent in only one direction, the turnaround times may be eliminated which only then makes possible real time data transmission and online diagnosis.

The solution according to the present invention, for example, makes possible recording of a complete shift process, according to a topographical road profile, in a vehicle transmission. Thus, the emerging transparency of the system facilitates improved service with maximum flexibility as available data, in real time, allows timely recognition of malfunctions and failures which can be prevented in the future by means of appropriate measures.

### BRIEF DESCRIPTION OF THE DRAWINGS

The present invention is illustrated in the FIGURE and will be explained in more detail hereinafter.

The only FIGURE shows a schematic illustration of the present invention, where the data of a vehicle 1 is transmitted, via an interface 2, to a cellular phone 3, which sends the data to a laptop 4.

### REFERENCE NUMERALS

1. Vehicle

2. Interface

3. Cellular phone

4. Laptop

1-3. (canceled)

4. An apparatus for real-time data transmission comprising:
an interface (2) for collecting the data and sending the data without any intermediate local storage; and
one of a cellular phone (3), a pocket personal computer (PC), a personal data assistant (PDA), a smartphone and a similar handheld device for executing a one-time transmission of the data to a remote destination.

5. A method of transmitting data, in real-time, by using one of a cellular phone (3), a pocket personal computer (PC), a personal data assistant (PDA), a smartphone and a similar handheld device, the method comprising the steps of:
collecting the data via an interface (2); and
transmitting the data from the an interface (2) in a single transmission.

6. The apparatus according to claim 4, wherein vehicle-specific values are calculated from the data during operation of the vehicle.

7. The method of transmitting data, in real-time, according to claim 5, further comprising the step of utilizing the data to calculate vehicle-specific values, during operation of the vehicle.

8. A method of accomplishing diagnosis of a remote vehicle, in real-time, independently of a request for transmission of data by using one of a cellular phone (3), a pocket personal computer (PC), a personal data assistant (PDA), a smartphone and a similar handheld device, the method comprising the steps of:
collecting the data via an adaptive, intelligent interface (2) in which all desired data and information is compiled; and
only transmitting the collected data and information from the an interface (2) in a single transmission.
